(19) United States
(12) Patent Application Publication
(10) Pub. No.: US 2006/0033605 A1
(43) Pub. Date: Feb. 16, 2006

(54) Locomotive security system and method

(76) Inventor: Norman L. Bridge, Naperville, IL (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/914,815

(22) Filed: Aug. 10, 2004

(51) Int. Cl. H04Q 1/00; G05B 19/00

(52) U.S. Cl. 340/5.72; 246/189; 340/5.6

(57) ABSTRACT

The present invention provides a locomotive security system and method, which applies a penalty brake to prevent unauthorized operation of a locomotive. The security system includes a security computer interfacing with an input device, a verification device and a locomotive penalty brake. Upon receiving appropriate identification information, from the input device, and a corresponding verification code, from the verification device, the security system allows an operator to operate the locomotive. The security system may also require reentry of the verification code periodically during locomotive operation to prevent application of the penalty brake. The system may be further used to transmit a distress signal, to signal authorities, when an unauthorized operator attempts to operate or continue to operate the locomotive.

### TECHNICAL FIELD

This invention relates to locomotive security systems and, more particularly, to locomotive security systems having a security computer operable to prevent unauthorized use of a locomotive by requiring identification information and a corresponding verification code.

### BACKGROUND OF THE INVENTION

Locomotive control lockout devices are known in the art to prevent locomotive theft and prevent unauthorized use. Such lockout devices create mechanical locks, which are commonly integrated into a direction controller console to prevent an unauthorized operator from shifting the locomotive into forward or reverse drive directions. This type of lockout device is commonly unlocked by inserting a reverser handle into a keyhole or socket within the control console to interlock a drive linkage within the console and thereby allow an operator to shift a locomotive from neutral to forward or reverse. However, reverser handles are designed to be universal or interchangeable between locomotives, thereby allowing almost any reverser handle to operate almost any locomotive. As a result, lost, misplaced, stolen or duplicated reverser handles may be used by an unauthorized individual to operate a locomotive or train. Therefore, a secure locking device that cannot be copied or misused is desired.

### SUMMARY OF THE INVENTION

The present invention provides a locomotive security system and method, which applies a penalty brake of a locomotive air brake system to prevent unauthorized operation of a locomotive. Upon receiving appropriate identification information and a corresponding verification code, the security system allows an operator to operate the locomotive. The security system may be further used apply the penalty brake and/or to transmit a distress signal, to signal authorities, when an unauthorized operator attempts to operate the locomotive.

The security system includes a security computer interfacing with an input device, a verification device and an output to initiate the penalty brake of the locomotive air brake system. The security computer determines the identity of an operator by receiving identity information from the input device and a verification code from the verification device. When the security computer receives improper identity information or an improper verification code the output initiates the penalty brake to prevent unauthorized operation of the locomotive. After the penalty brake is applied, the security computer releases the penalty brake after the security computer receives authorized identification information from the input device and a corresponding verification code from the verification device.

When identification information is entered into the input device, the security computer generates a corresponding verification code required to confirm the identity of the operator to prevent the application of the penalty brake. A verification code is then entered into the verification device. The verification code is then compared to the identification information, within the security computer, to determine and confirm the identity of the operator of the locomotive. When the correct verification code is entered in conjunction with the correct identification information, the security system allows the operator to operate the locomotive.

If desired, a transmitting device such as an antenna may be interfaced with the security computer for sending a distress signal, when unauthorized identification information or a verification code is entered into the security system, to alert authorities of an unauthorized operator attempting to operate the locomotive. In addition, a distress signal may be transmitted from the security system when a distressed operator enters a special verification code into the verification device.

After a period of time, the security system may signal the operator to reenter the verification data to determine if the same operator is in control of the locomotive. If the operator fails to enter the correct verification data within a reasonable amount of time, a locomotive shut down sequence will begin. Specifically, the security system will engage the penalty brake and remove locomotive traction power to bring the locomotive to a stop. During this time if the correct verification data is entered, the shut down sequence will abort and control of the locomotive will revert to the operator.

These and other features and advantages of the invention will be more fully understood from the following description of certain specific embodiments of the invention taken together with the accompanying drawings.

### BRIEF DESCRIPTION OF THE DRAWINGS

FIG. 1 is a diagrammatic view of a locomotive security system according to the present invention; and

FIG. 2 is a diagrammatic view of an alternative embodiment of a locomotive security system similar to the security system of FIG. 1.

### DESCRIPTION OF THE PREFERRED EMBODIMENT

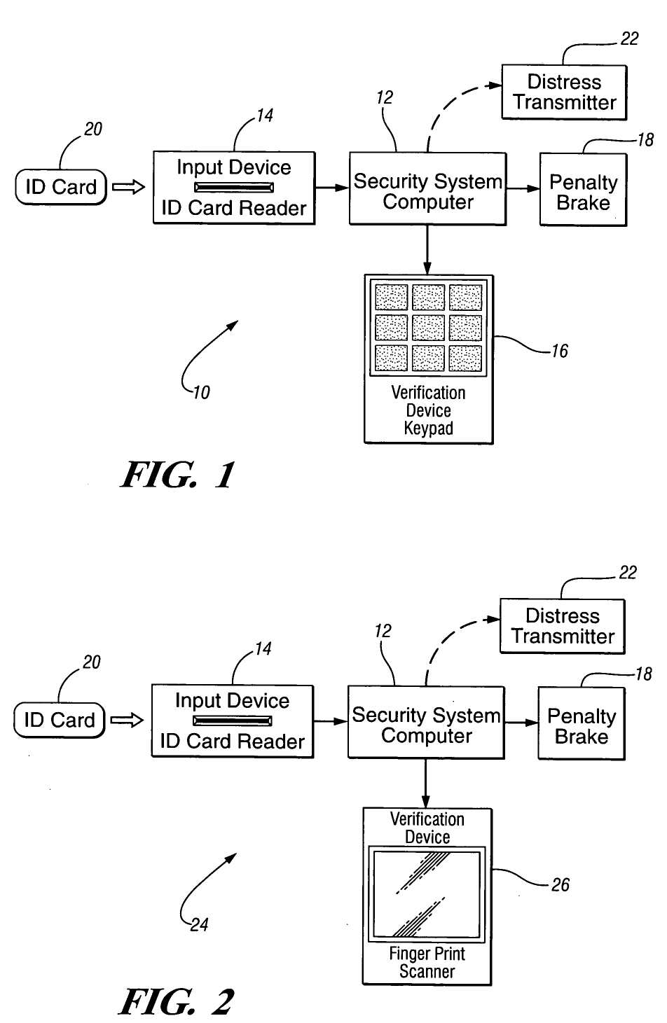

Referring now to FIG. 1 of the drawings in detail, numeral 10 generally indicates a security system for use with a railway locomotive, the operation of which prevents unauthorized use of the locomotive when an unauthorized operator attempts to operate the locomotive. The security system 10 includes a security computer 12 interfacing with an input device 14, a verification device 16 and a penalty brake 18 of a locomotive airbrake system.

The penalty brake 18 may be of any type known in the art and may be controlled pneumatically, mechanically or electronically to apply the conventional air brakes of the locomotive in a controlled manner to safely bring the locomotive to a full service stop. In addition, an interlocking relay connected between the penalty brake 18 and a generator field contactor, not shown, removes power to the traction motors of the locomotive when the penalty brake is applied.

The input device 14 may include a magnetic ID card reader or a smart card reader. The input device 14, upon receiving an ID card 20, reads identity information contained within the ID card and transmits the information to the security computer 12. If desired, the ID card 20 may also contain an encrypted verification code corresponding with the identity information, which may also be read by the input device and transmitted to the security computer 12.

The verification device 16 is a key pad, which upon receiving a verification code, transmits the verification code to the security computer 12. The verification code is preferably a multiple digit personal identification number (PIN).

The security computer 12 operates by comparing identification information to a generated required verification code to prevent application of the penalty brake 18 and thereby allow an authorized operator to operate the locomotive. The required verification code may be generated in two ways.

In a first method, the required verification code is generated by the security computer 12. This may be done by assigning the identification information a value (i.e., a check sum) and using an algorithm to convert the value into a required verification code, which is also known by the operator.

In a second method, the security computer 12 decrypts the encrypted verification code received from the ID card 20 to generate the required verification code.

Once the identification information and the required verification code are known by the security computer 12, the security computer awaits an authorized verification code from the verification device 16. When a verification code is entered, into the verification device 16, the security computer 12 compares the verification code from the verification device 16 to the required verification code generated by the security computer 12. Upon a match, the security computer 12 allows operation of the locomotive.

If desired, a transmitting device 22 such as an antenna may be interfaced with the security computer 12. The transmitting device 22 operates to send distress signals from the locomotive, when unauthorized identification information or verification codes are entered into the security system 10. In addition, distress signals may be transmitted from the transmitting device 22 when a distressed operator enters a special verification code into the verification device 16.

When an operator desires to operate the locomotive, the operator inserts an ID card 20 into the input device 14. The information contained within the ID card 20 is read by the input device 14 and then transferred to the security computer 12. Once the information is received by the security computer 12, the security computer generates the required verification code, as previously described, and signals the operator to enter a corresponding verification code into the verification device 16. If desired the security computer 12 may allow the operator to reenter the verification code several times to accommodate operator errors in inputting the verification code into verification device 16. The verification code from the verification device 16 is then transmitted to the security computer 12 and compared to the required verification code to confirm the operators identity. Upon entry of an authorized verification code, the security computer allows the locomotive to load to allow the operator to operate the locomotive normally.

If an improper verification code or improper identity information is entered into the security system 10, the security computer will apply the penalty brake 18 to prevent unauthorized operation of the locomotive.

After a period of time, the security system 10 may signal the operator to reenter the verification code into the verification device 16 to determine if the previously authorized operator is in control of the locomotive. If the operator fails to enter the correct code within a reasonable amount of time, a locomotive shut down sequence will begin. Specifically, the security system 10 will engage the penalty brake 18, which will preferably, remove locomotive traction power and engage the brakes of the locomotive adequately to bring the locomotive to a stop. During this time, if the correct verification code is entered, the shut down sequence will abort and control of the locomotive will revert to the operator.

In addition to applying a penalty brake, the security system 10 may also transmit a distress signal from the transmitting device 22 upon receiving an improper verification code or improper identity information to alert authorities of an unauthorized operation of the locomotive.

FIG. 2 illustrates an alternative embodiment of the invention wherein a security system 24 uses a biometric verification device 26 instead of the keypad verification device 16 of the security system 10. The biometric verification device 26 may include a fingerprint scanner, a retinal scanner, a voice recognition device, or other suitable apparatus. The security system 24 also includes a security computer 12 interfacing with an input device 14 and a penalty brake 18, all of which are functionally similar to security system 10 of FIG. 1.

Thus, security system 24 when installed in a locomotive operates in a manner similar to security system 10 in that the security computer 12 applies a penalty brake 18 whenever an improper verification code or identity information are entered into the security system. Once the penalty brake is applied, the security computer 12 releases the penalty brake 18 after an authorized operator enters authorized identification information into the input device 14 and a corresponding biometric verification code into the verification device 26, for example a fingerprint. The security system 24, upon receiving corresponding identification information and a biometric verification code releases the penalty brake 18, thereby allowing the operator to operate the locomotive. The remaining features and operation of the security system 24 are as described previously with respect to the embodiment of FIG. 1.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A security system for use in preventing unauthorized operation of a locomotive, the system comprising:
a security computer interfacing with an input device, a verification device and a locomotive penalty brake;
the security computer operable to apply the penalty brake to prevent unauthorized use of the locomotive;
the input device operable to receive operator identity information and transmit the identity information to the security computer;
the verification device operable to receive a verification code and transmit the verification code to the security computer;
the security computer operative to compare the identity information and the verification code to determine if use of the locomotive is authorized; and
the security computer operative to apply the penalty brake when use of the locomotive is determined to be unauthorized.

2. A system as in claim 1 wherein the identity information is stored on an ID card readable by the input device.

3. A system as in claim 2 wherein the ID card also contains an encrypted verification code corresponding with the identity information.

4. A system as in claim 3 wherein the verification device is a keypad.

5. A system as in claim 3 wherein the verification code is biometric information.

6. A system as in claim 5 wherein the verification device is a biometric reader.

7. A system as in claim 1 wherein application of the penalty brake removes traction power to the traction motors of the locomotive and applies adequate braking force to prevent movement of the locomotive.

8. A system as in claim 1 including a transmitter interfacing with the security computer and operable to transmit a distress signal when the identity information and the verification code do not correspond.

9. A method of preventing unauthorized use of a locomotive including the steps of:
providing a security computer interfacing with an input device, a verification device and a locomotive penalty brake;
inputting operator identity information into the input device and transmitting the identity information to the security computer;
inputting a verification code into the verification device and transmitting the verification code to the security computer; and
comparing the identity information and the verification code and applying the penalty brake if the identity information and the verification information indicate an unauthorized operator.

10. A method as in claim 9 including initiating a reverification process signaling the operator of the locomotive after a period of time to reenter the verification code into the verification device and the security computer applying the penalty brake if the verification code is not entered.

11. A method as in claim 9 including transmitting a distress signal from a transmitter when unauthorized identity information or verification codes are inputted into the security computer.

12. A method as in claim 9 including inputting an encrypted verification code into the input device and transmitting the encrypted verification code to the security computer.

13. A method as in claim 12 including decrypting the encrypted verification code and storing the decrypted verification code within the security computer to generate a required verification code stored within the security computer.

14. A method as in claim 9 including generating a required verification code within the security computer based on operator identity information.
